(19) United States
(12) Patent Application Publication
(10) Pub. No.: US 2003/0135298 A1
(43) Pub. Date: Jul. 17, 2003

(54) Generating device for CNC drilling program

(76) Inventor: Ming Hung Wu, Taipei City (TW)

Correspondence Address: WU, Ming Hung, PO Box 82-144, TAIPEI, TW

(21) Appl. No.: 10/046,385

(22) Filed: Jan. 16, 2002

(51) Int. Cl. G06F 19/00

(52) U.S. Cl. 700/160; 700/86

(57) ABSTRACT

A generating device for CNC drilling program and the method of generating CNC drilling program and RAM for computer to allow computer to execute production of CNC drilling program. The generating device for CNC drilling program can accomplish the tedious printing arrangement and calculation work based on the customer's original drilling program and the inputting drilling-hole numerical data. The precision of the present device is high and the efficiency of drilling is obtained.

### BACKGROUND OF THE INVENTION

(A) Field of Invention

This invention relates to a CNC (computer numeric control), and in particular, a generating device for CNC drilling program and the method of producing CNC drilling program and the recording media used for the same.

(B) Description of the Prior Art

As shown in FIG. 1, CN C drilling program needs a plurality of tedious steps and calculation in order to achieve its object. The original program has to be input into CAD/CAM, and then proceed to printing arrangement, and editing steps and it normally takes up several hours. By means of PE2 software to edit and calculate to proceed with zero point setting, drill conversion, printing holes, inspection hole, making of opening, and circular holes. All these have to be calculated manually and then inputted into PE2 program It is laborious and time consuming and this will affect the production operation.

As the operation needs to be operated under PE2 and CAD/CAM, there are human errors occurred and rectification process is needed and therefor the working efficiency cannot be improved. Accordingly, it is an object of the present invention to provide a generating device for CNC drilling program, which overcomes the above-mentioned drawbacks.

### SUMMARY OF THE INVENTION

The present invention is directed to a generating device for CNC drilling program, wherein the customer provides only the original program and the input drilling holes numerical data, the present generating device for CNC drilling program can complete the tedious steps of printing arrangement and calculation steps without employing CAD/CAM and PE2 or manual calculation. Thus, operation cost for such is greatly saved.

It is an object of the invention to provide a generating device for CNC drilling program, wherein the production of CNC drilling program is automatic.

Yet an object of the invention to provide a generating device for CNC drilling program, wherein a recording media for production of CNC drilling program is provided.

Features and advantages of the invention will be evident from the following detailed description of the preferred embodiment described in conjunction with the attached drawings.

### BRIEF DESCRIPTION OF THE DRAWINGS

FIG. 1 is flowchart of a conventional method to produce CNC drilling program.

FIG. 2 is flowchart for the generating device for CNC drilling program in accordance with the present invention.

FIG. 3 is a display page of the generating device for CNC drilling program in accordance with the present invention.

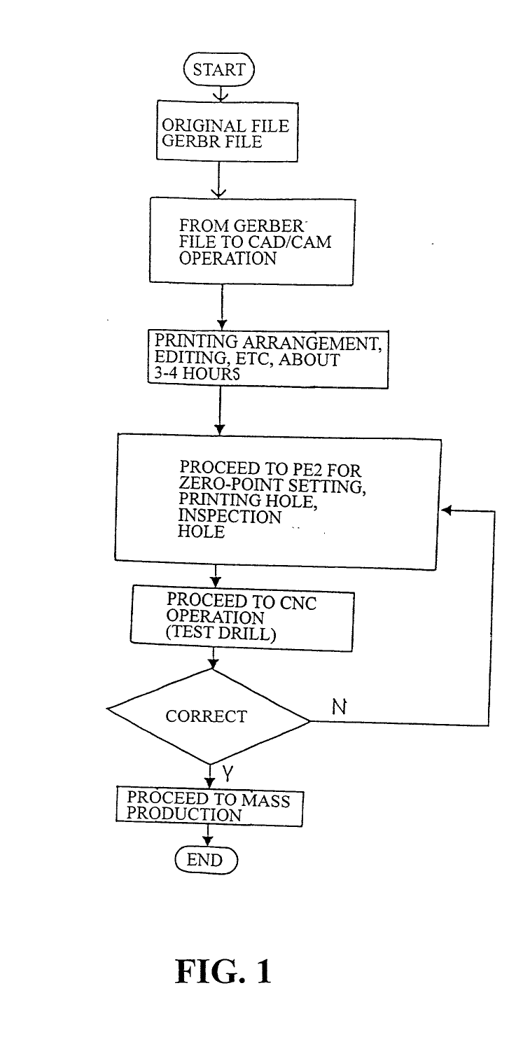

### DETAILED DESCRIPTION OF THE PREFERRED EMBODIMENT

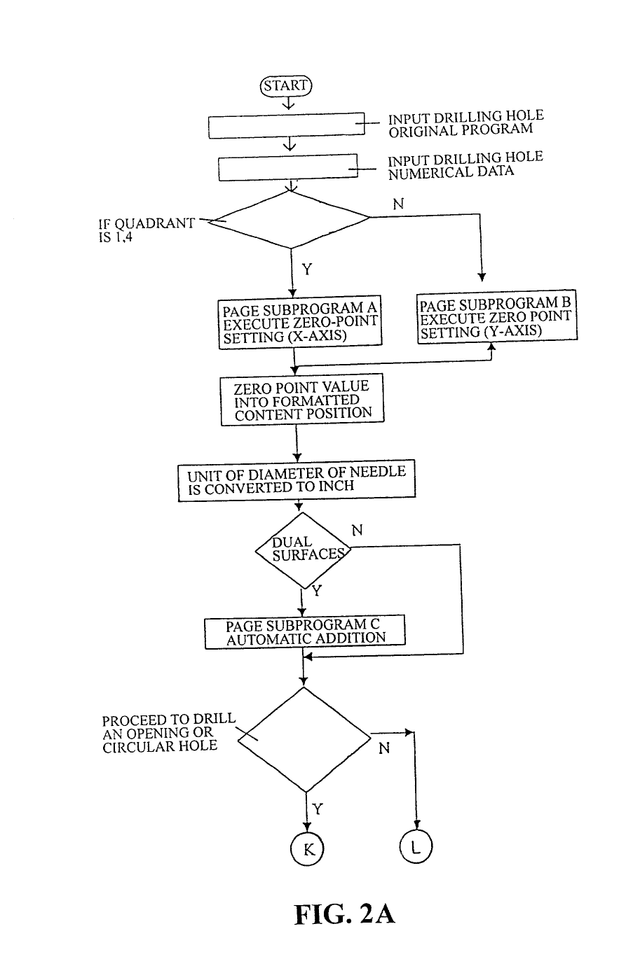

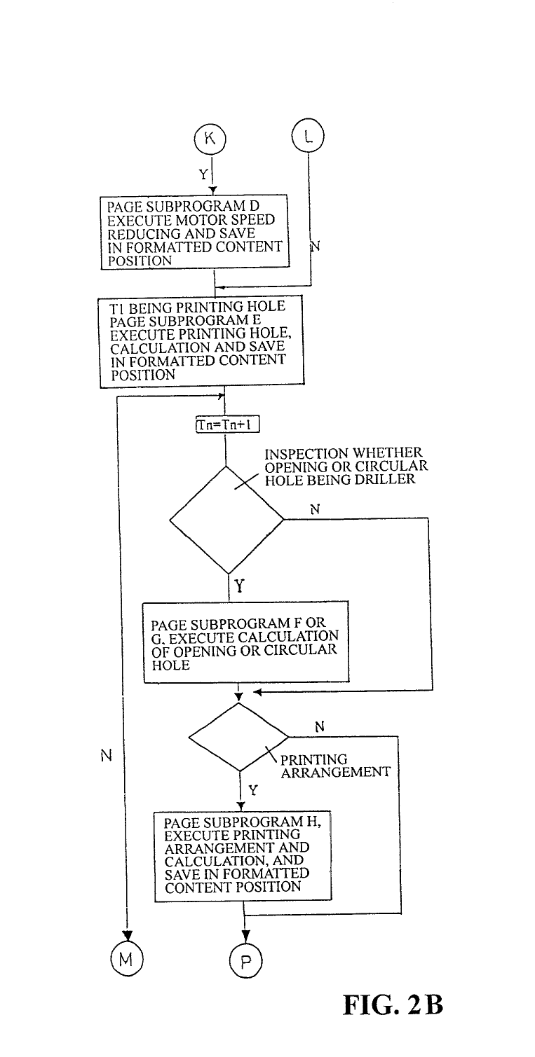

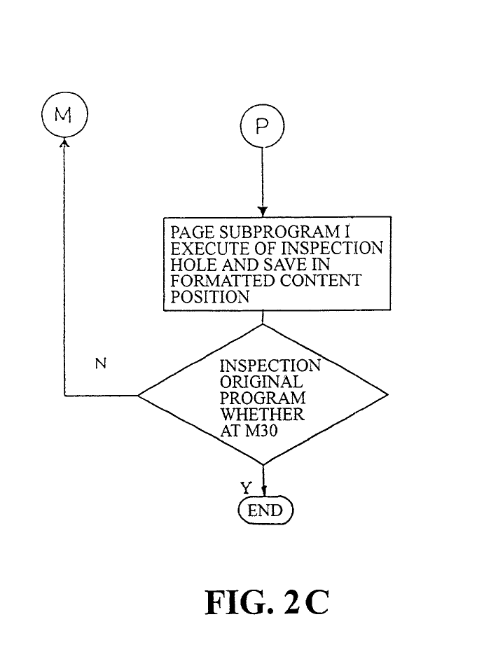

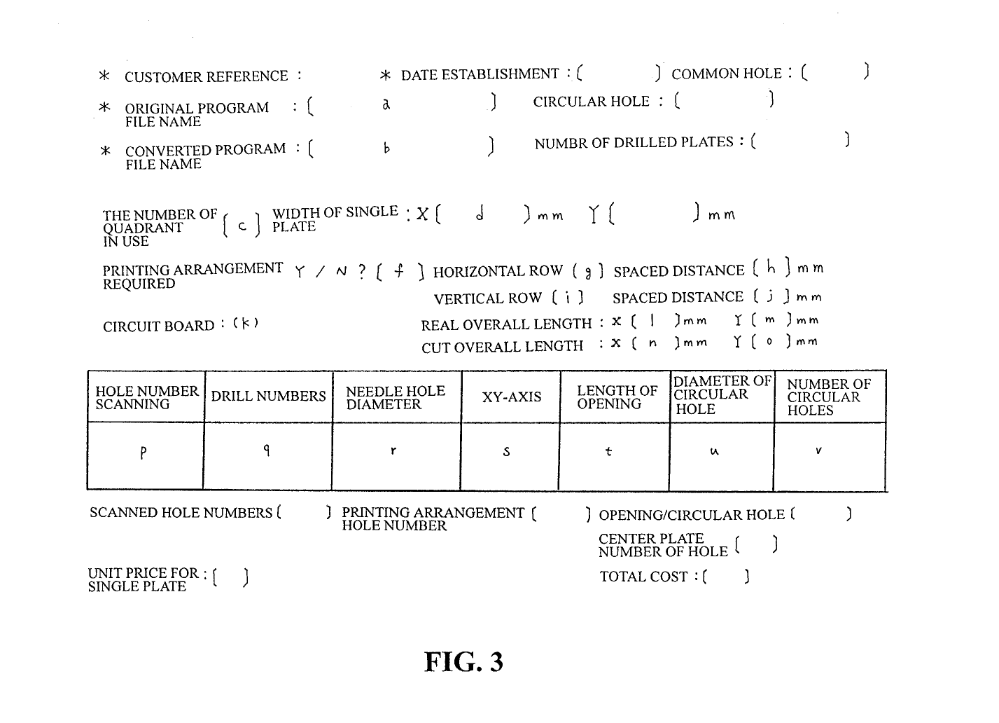

With reference the drawings, in particular to FIGS. 2 and 3, there is shown a flowchart of producing CNC drilling program in accordance with the present invention. A customer must provide the original program for drilling hole and input the program at column a of the path file name of the original program shown in FIG. 3. The scanning device of the present generating device scan the original program for drilling hole to obtain the number of drills and the coordinates of the drilling hole data and are display at column q of Number of Drills shown in FIG. 3. The customer can designate the storage of the accomplished CNC drilling program into column b of the conversion program path file name.

The drilling hole numerical data are input in sequence as shown in FIG. 3 by the customer, and these data include the quadrant at column c, the width X and the height Y of the single plate respectively at column d and e and determine whether proceed to printing arrangement (Y/N) at f. If printing arrangement is needed the number of plate on the horizontal row has to be inputted into column g and the spaced distance shall be inputted at column h, the number of plate on the vertical row has to be inputted into column I and the spaced distance between vertical row shall be inputted at column j. In addition, the selection of circuit board being either a single face or a dual face is made at column k. After the above data has been inputted, the CNC drilling program generating device will preliminary calculate the exact total length and width to display at column l and m and the total length and width of the cut board are shown at column n and o.

Based on the original program of the drilling hole, the number of drills (for instance, T1, T2) will be shown in column q. The diameter of the drilling needle should be inputted at column r. If an opening or a circular hole is required, the column s has to be inputted with X or Y, showing that an opening or a circular hole is made at the X-axis or the Y-axis, and the length of the opening or the diameter of the circular hole is made at column t or u. At this instance, the numerical data of the drilling hole has been fully inputted. The present generating device will automatically calculate a drilling program which can be executed on the CNC tool.

Based on the original program and the numerical data of the drilling hole, if the quadrant for input is 1 or 4, sub program A is page and the calculation of the zero point setting (X-axis) is executed as follows:

Q=12.008−x/2/25.4 (1)

wherein x is the real total length and width. The value of Q is a 6-digit with 2 numbers in front of the decimal, otherwise, a zero has to be supplemented and no decimal has to be denoted. For instance, if the value for Q is 1.234. Then the number in the column should be 012340.

If the utilize quadrant is 2 or 3, sub program B is page to execute the calculation of zero-point setting (Y-axis). Equation 2 is shown as follows:

Q=12.008−y/2/25.4 (2)

wherein y is the real total overall length and width.

Based on the input numerical data, the diameter of the needle is in mm and it must be converted to inch. Based on the equation for common hole, C[T]:T is the needle diameter/25.4

For square hole, C[T]: 1.2 mm/25.4

For circular hole, C[T]: 3.0 mm/25.4

Based on the value at the column k, whether the circuit board is single face or a dual face can be determined. For dual surface, sub program C is page.

The diameter of each needle has to be added 0.15 inch and is saved at the formatted content position.

For specific needle to proceed with opening or circular hole, sub-program D is page and the automatic speed reducing of motor is executed and is saved at the formatted content position.

For drilling program format, the first drill (T01) secures the drilling printing hole. At this instance, sub program E is page to execute the calculation of printing hole. If the printing holes are 4, the position of the printing holes are determined based on the size of the cut board and the coordinates are calculated as follow and the calculated values are converted into a specific format and saved at the formatted content position.

(0, −3.8/25.4) (3)

(x/25.4, −3.8/25.4) (4)

(x/25.4, (y+3.8)/25.4) (5)

(0, (y+3.8)/25.4) (6)

After the coordinate for the position of the printing hole is calculated, the coordinate of the position of the inspection hole (0.2, −3.8/25.4) is calculated and is saved in the formatted content position.

After the first drill (T01) has completed the drilling of the printing hole, the data of the first drill within the drilling original program is obtained and a second drill (T02) is used. Similarly all the drill data within the original program is added with 1. Next inspection to determine either an opening or a circular hole. If the sub-program F and G is proceeded if such drill is needed to execute the opening or the circular hole calculation and is saved in formatted content position. The calculation of opening is as follows:

(t−r)/2/25.4=L (inch) (7)

If Y axis does not change, the value at the formatted content is X

(n+L)YmG85X(n−L)Ym (8)

If X axis does not change, the value at the formatted content is XnY

(m+L)G85XnY(m−L) (9)

wherein t is the length of the opening, r is the diameter of the drilling needle, n is the X axis coordinate of the original program, m is the Y axis coordinate of the original program.

The calculation of the circular hole is as follows:

[u−(3.0/2)]/25.4=P (inch) (10)

XnYmG84P (11)

wherein u is the diameter of the circular hole, n is the X axis coordinate of the original program, and m is the Y axis coordinate of the original program. If printing arrangement is needed, subprogram H is page and calculation of printing arrangement is executed. The purpose of printing arrangement is that repeat drilling of the horizontal and vertical plates under the similar drills and the same original program. Thus the calculation for printing arrangement based on the number of plate and spaced apart of the vertical and horizontal rows and the formatted content value is as follows:

R(g−1)M20X[(d+h)/25.4]Y (12)

R(i)M20XY[(e+j)/25.4] (13)

wherein d is the input value for the width of a single plate, e is the input value for the height of the single plate, g is the number of plate for the input horizontal row, and h is the spaced distance of the input horizontal row, i is the number of plate for the input vertical row, and j is the spaced distance of the input vertical row.

After each drill has completed the drilling the hole has to be inspected and the drill being damaged or not has also been inspected. After the drill has completed the drilling of the circuit board, sub program I is page and the calculation for the position of the inspection hole has to be executed and is saved at formatted content position.

If the original program is at M30, the program is completed and no drill is in existence. The drilling hole program must be ended with M30. If M30 has not been reached this indicates that there is another drill and the LOOP1 of the flowchart in FIG. 2 has to be repeated until the program is ended.

In accordance with the present invention, the generating device includes a display interface. As shown in FIG. 3, the required drilling numerical data must be inputted and calculate the total drilling holes number and the quoted charges. Thus the used can obtained a quoted charge from the screen of the display and the CNC drilling program without manual calculation. The efficiency of the CNC drilling program generation is improved.

In accordance with the present invention, the function of the sub program is as follows:

A: zero point setting (X-axis)

B: zero point setting (Y-axis)

C: Automatic adding

D: Motor automatic speed reducing

E: Printing hole

F: Opening calculation

G: Circular hole calculation

H: Printing arrangement calculation

I: Inspection hole.

The present invention also relates to a method of using a program to generate CNC drilling program comprises the following steps: receiving the original program for drilling hole; inputting drilling hole numerical data; calculating zero-point setting value based on the original program and the drilling hole numerical data; performing calculation for an opening or circular hole based on the original program and the drilling hole numerical data; and performing printing-arrangement calculation based on the drilling hole numerical data.

By means of the scanning drills of the original program, the number of drills and the coordinate of drilling hole can be obtained. To input the drilling hole numerical data, the utilized quadrant, the width and height of the single plate, the length, width and the number of the printing arrangement, single surface or dual surfaces of the circuit board, the diameter of the drill, the size of the opening or the circular hole have to be inputted. The above data will be displayed at the screen and the total number of drilling hole and the quoted charges for the drilling holes will be displayed.

In view of the above, the customer provides only the original program and the input drilling holes numerical data, the present generating device for CNC drilling program can complete the tedious steps of printing arrangement and calculation steps without employing CAD/CAM and PE2 or manual calculation. Thus, operation cost for such is greatly saved.

The above method is completed using computers and the computer programs can be stored in RAM media such as diskette, optical disc, hard disc, IC memories.

It is to be understood that the description of the preferred embodiment is intended to be only illustrative, rather than exhaustive, of the present invention. Those of ordinary skill will be able to make certain additions, deletions, and/or modifications to the embodiment of the disclosed subject matter without departing from the spirit of the invention or its scope, as defined by the appended claims.

I claim:

1. A generating device for CNC drilling program comprising a scanning device for scanning the original program for hole-drilling;
an input device for inputting hole-drilling numerical data;
a zero-point setting calculation device for producing zero-point setting value based on the original program and hole-drilling numerical data;
a hole-drilling calculation device for executing the calculation of an opening or a circular hole based on the original program and hole-drilling numerical data; and
a printing arrangement calculation device for executing printing arrangement based on drilling-hole numeric data.

2. The generating device as claimed in claim 1, wherein the scanning device proceeds to scan to obtain the number of drills and the coordinates of drilling-holes.

3. The generating device as claimed in claim 1, wherein the drilling-hole numerical data include the width and height of the single plate, the length, width and numbers of the printing arrangement, single or dual surface of circuit board, the diameter of the drills, the size of the opening and circular hole.

4. The generating device as claimed in claim 1, further comprises an adding calculation device.

5. The generating device as claimed in claim 1, further comprises a printing hole calculation device for deciding the position of the printing hole based on the size of the circuit board.

6. The generating device as claimed in claim 1, further comprises an inspection hole calculation device for calculating the position of the inspection hole for each drilling needle to inspect whether the drilling needle is damaged or not.

7. The generating device as claimed in claim 1, further comprises a display device to display the necessarily inputting drilling-hole numerical data and to display the total drilling holes and a quoted cost after calculation.

8. A method of generating CNC drilling program comprising the steps of:
receiving the original program for drilling hole;
inputting drilling hole numerical data;
calculating zero-point setting value based on the original program and the drilling hole numerical data;
performing calculation for an opening or circular hole based on the original program and the drilling hole numerical data; and
performing printing-arrangement calculation based on the drilling hole numerical data.

9. The method of claim 8, further comprises the step of scanning original program of drilling hole to obtain the number of drills and the coordinates of drilling-holes.

10. The method as claimed in claim 8, wherein the drilling-hole numerical data input step includes the steps of inputting the width and height of the single plate, the length, width and numbers of the printing arrangement, single or dual surface of circuit board, the diameter of the drills, the size of the opening and circular hole.

11. The method as claimed in claim 8, further comprises the step of an adding calculation step.

12. The method as claimed in claim 8, further comprises a printing hole calculation step for deciding the position of the printing hole based on the size of the circuit board.

13. The method as claimed in claim 8, further comprises an inspection hole calculation step for calculating the position of the inspection hole for each drilling needle to inspect whether the drilling needle is damaged or not.

14. The method as claimed in claim 8, further comprises a display step to display the necessarily inputting drilling-hole numerical data and to display the total drilling holes and a quoted cost after calculation.

15. A method of recording in RAM in a computer to produce CNC drilling program comprising the steps of receiving the original program for hole-drilling;
receiving inputting hole-drilling numerical data;
a zero-point setting calculation step for producing zero-point setting value based on the original program and hole-drilling numerical data;
an opening and circular hole calculation step based on the original program and hole-drilling numerical data; and
a printing arrangement calculation step based on drilling-hole numeric data.

16. The method of claim 16, further comprises the step of scanning original program of drilling hole to obtain the number of drills and the coordinates of drilling-holes.

17. The method as claimed in claim 15, wherein the drilling-hole numerical data input step includes the steps of inputting the width and height of the single plate, the length, width and numbers of the printing arrangement, single or dual surface of circuit board, the diameter of the drills, the size of the opening and circular hole.

18. The method as claimed in claim 15, further comprises the step of an adding calculation step.

19. The method as claimed in claim 15, further comprises a printing hole calculation step for deciding the position of the printing hole based on the size of the circuit board.

20. The method as claimed in claim 15, further comprises an inspection hole calculation step for calculating the position of the inspection hole for each drilling needle to inspect whether the drilling needle is damaged or not.

21. The method as claimed in claim 15, further comprises a display step to display the necessarily inputting drilling-hole numerical data and to display the total drilling holes and a quoted cost after calculation.
